(19) United States
(12) Patent Application Publication
(10) Pub. No.: US 2026/0055232 A1
(43) Pub. Date: Feb. 26, 2026

(54) POLYESTER RESIN, BINDER FOR PIGMENT PRINTING, INK FOR PIGMENT PRINTING, AND PRODUCTION METHOD FOR POLYESTER RESIN

(71) Applicant: NICCA CHEMICAL CO., LTD., Fukui-shi, Fukui (JP)

(72) Inventors: Naoko YABE, Fukui-shi, Fukui (JP); Takeshi YOSHIDA, Fukui-shi, Fukui (JP); Kazuhiko KUWANO, Fukui-shi, Fukui (JP)

(21) Appl. No.: 19/112,003

(22) PCT Filed: Aug. 1, 2023
(86) PCT No.: PCT/JP2023/028124

§ 371 Date: Mar. 14, 2025

(30) Foreign Application Priority Data
Sep. 20, 2022 (JP) 2022-149510

(51) Int. Cl. C08G 63/91; C08G 63/85; C08J 3/05; C09D 11/104

(52) U.S. Cl. CPC C08G 63/916; C08G 63/85; C08J 3/05; C09D 11/104; C08G 2150/00; C08J 2367/02

(57) ABSTRACT

A polyester resin that is a polycondensate of a raw material including (a) polyethylene terephthalate and (b) an aliphatic diol having 6 to 16 carbon atoms, in which the content of the component (a) in the raw material is 30 to 80 mol % with respect to the total amount of the raw material, and the content of the component (b) in the raw material is 20 to 50 mol % with respect to the total amount of the raw material.

### TECHNICAL FIELD

The present disclosure relates to a polyester resin, a binder for pigment printing, an ink for pigment printing, and a production method for a polyester resin.

### BACKGROUND ART

Binder resins are required to have various performances such as fastness to rubbing, heat resistance, and chromogenic properties depending on their use, and in particular, binder resins for printing that are intended for use in textile products are required to have high washing durability, flexibility of a printed portion, and tack-free properties.

For example, Patent Literature 1 discloses an ink set including an inkjet ink including a pigment and a cationic dispersant, and a treatment liquid including polyester resin particles (that is, a resin emulsion), in which the resin emulsion is a forced emulsification type resin emulsion further including an anionic surfactant, or the polyester resin is an anionic self-emulsification type resin emulsion, so that a printed article excellent in fastness to rubbing can be formed.

Further, in Patent Literature 2, by using an ink including colored particles including a disperse dye and a polyester resin and water, the polyester resin in the ink is integrated with polyester fibers through a simple heat treatment, and the disperse dye in the ink dispersed in a molecular state is diffused on the surfaces of the polyester fibers, so that a uniform finish is obtained.

### CITATION LIST

### Patent Literature

Patent Literature 1: Japanese Unexamined Patent Publication No. 2021-176935
Patent Literature 2: Japanese Unexamined Patent Publication No. 2019-182941

### SUMMARY OF INVENTION

### Technical Problem

However, the polyester resin of Patent Literature 1 has a problem of poor washing durability. In addition, the polyester resin of Patent Literature 2 has a problem that texture is hard and flexibility is poor.

The present disclosure has been made in view of the above circumstances, and an object thereof is to provide a polyester resin excellent in washing durability and flexibility, a production method for a polyester resin, a binder for pigment printing including such a polyester resin, and an ink for pigment printing.

### Solution to Problem

The present disclosure includes the following embodiments [1] to [10].

[1]

A polyester resin that is a polycondensate of a raw material including (a) polyethylene terephthalate and (b) an aliphatic diol having 6 to 16 carbon atoms, in which
a content of the component (a) in the raw material is 30 to 80 mol % with respect to a total amount of the raw material, and
a content of the component (b) in the raw material is 20 to 50 mol % with respect to the total amount of the raw material.
   [2]

The polyester resin according to [1], in which the aliphatic diol is a linear aliphatic diol.

[3]
The polyester resin according to [1] or [2], in which the raw material further includes at least one selected from the group consisting of a trihydric or higher polyhydric alcohol component and a tricarboxylic or higher polycarboxylic acid component.
[4]

The polyester resin according to [3], in which the polycarboxylic acid includes 4 to 12 carbon atoms.

[5]

The polyester resin according to at least one of [1] to [4], in which the polyester resin is a reaction product obtained by reacting the polycondensate with a tricarboxylic or higher polycarboxylic acid component.

[6]

The polyester resin according to at least one of [1] to [5], having an acid value of 5 to 20 mg KOH/g.

[7]

A binder for pigment printing, including an aqueous emulsion dispersion of the polyester resin according to at least one of [1] to [6].

[8]

An ink for pigment printing, including the binder for pigment printing according to [8].

[9]

A production method for a polyester resin,
the method including the step of polycondensing a raw material to obtain a polycondensate, in which
the raw material includes (a) polyethylene terephthalate and (b) an aliphatic diol having 6 to 16 carbon atoms,
a content of the component (a) in the raw material is 30 to 80 mol % with respect to a total amount of the raw material, and
a content of the component (b) in the raw material is 20 to 50 mol % with respect to the total amount of the raw material.
   [10]

The production method for a polyester resin according to [10], further including the step of reacting a tricarboxylic or higher polycarboxylic acid component with the polycondensate obtained.

### Advantageous Effects of Invention

The present disclosure can provide a polyester resin excellent in washing durability and flexibility a production method for a polyester resin, a binder for pigment printing including such a polyester resin, and an ink for pigment printing.

### DESCRIPTION OF EMBODIMENTS

The polyester resin of the present embodiment is a polyester resin that is a polycondensate of a raw material including (a) polyethylene terephthalate and (b) an aliphatic diol having 6 to 16 carbon atoms, in which the content of the component (a) in the raw material is 30 to 80 mol % with respect to the total amount of the raw material, and the content of the component (b) in the raw material is 20 to 50 mol % with respect to the total amount of the raw material. Such a polyester resin is excellent in washing durability and flexibility. In addition, the polyester resin of the present embodiment tends to be excellent in tack-free properties.

The polyester resin of the present embodiment has a polyethylene terephthalate block. The polyethylene terephthalate block is a block having a structure in which two or more of the following structural units (1) are repeatedly bonded. In the present description, the content of polyethylene terephthalate in the raw material or the polyethylene terephthalate block in the polyester resin is represented by the content (mol or the like) of the following structural unit (1).

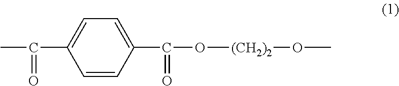

The reason why the polyester resin of the present embodiment is excellent in washing durability and flexibility is not necessarily clear, bit since a polycondensation reaction is performed on PET as a raw material, a polyethylene terephthalate block is introduced into the obtained polyester resin. It is considered that the strength of the resin is improved by the polyethylene terephthalate block, whereby the washing durability is excellent. Also, it is considered that because the polyester resin of the present embodiment includes a unit derived from an aliphatic diol having 6 to 16 carbon atoms, the polyester resin of the present embodiment is superior in flexibility to conventional polyester resins for printing.

Typically, the raw material of the polyester resin of the present embodiment includes polyethylene terephthalate (PET) in order to introduce a polyethylene terephthalate block into the polyester resin, and further includes an aliphatic diol having 6 to 16 carbon atoms as a polyhydric alcohol component. The raw material may optionally include a polycarboxylic acid component or a polyhydric alcohol other than the component (b). PET is incorporated into a polymer chain of a polyester resin by polycondensation with a polyhydric alcohol component or a polycarboxylic acid component included in a raw material. In the polycondensation reaction, all the raw material may be mixed and reacted, or the reaction may be performed in two or more stages. PET as a raw material may be depolymerized in advance before the polycondensation reaction, or may be depolymerized during the polycondensation reaction.

There are no limitations on the molecular weight distribution, composition, production method, form in use, and the like of PET to be used. The PET may be PET produced from a raw material derived from petrochemical, bio-PET produced from a raw material derived from biomass, or recycled PET collected from waste. The recycled PET is usually processed into a flake shape or a pellet shape, and may have a weight average molecular weight of about 30,000 to 90,000.

The intrinsic viscosity (IV) of PET at room temperature (25° C.) may be 0.6 to 0.9. The IV can be measured according to the method of JIS K7390 (2003).

The content of PET in the raw material is 30 to 80 mol % with respect to the total amount of the raw material, and from the viewpoint of further improving washing durability or flexibility, it is preferably 35 mol % to 70 mol %, and more preferably 40 mol % to 65 mol %. When the content is less than 30 mol %, the number of the robust polyethylene terephthalate block structures is reduced, as a result of which the fabric is not resistant to friction during washing, and the printed portion is easily peeled off from the base material. When the content is more than 80 mol %, the number of the robust PET structures is too large, the printed portion becomes hard, and it becomes impossible to follow the elongation, bending, and the like of the base material.

The total content of the PET depolymerized product in the raw material can be calculated from the mass of PET charged as the number of moles of the unit of [terephthalic acid:ethylene glycol](structural unit of the general formula (1)).

Components (monomer components) other than PET or an aliphatic diol having 6 to 16 carbon atoms in the raw material can be 50 mol % or less, 45 mol % or less, or 40 mol % or less with respect to the total amount of the raw material.

### <Polyhydric Alcohol Component>

### (Diol)

The polyester resin of the present embodiment includes a unit derived from an aliphatic diol having 6 to 16 carbon atoms as a unit derived from a polyhydric alcohol component. Thus, the raw material of the polyester resin includes an aliphatic diol having 6 to 16 carbon atoms. In the present description, the unit derived from the polyhydric alcohol component refers to a structural unit having a chemical structure obtained by polycondensation of the polyhydric alcohol.

The aliphatic diol having 6 to 16 carbon atoms may be a linear or branched diol, or may be a linear diol. Examples of the linear aliphatic diol having 6 to 16 carbon atoms include 1,6-hexanediol, 1,7-heptanediol, 1,8-octanediol, 1,9-nonanediol, 1,10-decanediol, and 1,12-dodecanediol. As the aliphatic diol having 6 to 16 carbon atoms, one kind or two or more kinds can be used. Examples of the branched aliphatic diol having 6 to 16 carbon atoms include 2,4-dimethyl-2,4-pentanediol, 2,5-hexanediol, 2,5-dimethyl-2,5-hexanediol, 1,2-decanediol, 2,2-diethyl-1,3-propanediol, 1,2-hexanediol, 1,2-octanediol, 1,2-hexadecanediol, 3-methyl-1,5-pentanediol, i-tert-butyl-1,2-ethanediol, 3-ethoxypropane-1,2-diol, 1,4-octanediol, 1,5-heptanediol, and 2,7-octanediol.

The content of the aliphatic diol having 6 to 16 carbon atoms in the raw material is preferably 25 to 47 mol %, and more preferably 30 to 45 mol % with respect to the total amount of the raw material.

The polyhydric alcohol component may include a diol other than the aliphatic diol having 6 to 16 carbon atoms. Examples of such a diol include an aliphatic diol having 5 or less carbon atoms or 17 or more carbon atoms, an aromatic diol, and an alicyclic diol. The aliphatic diol having 5 or less carbon atoms or 17 or more carbon atoms may be a linear or branched diol.

Examples of the aliphatic diol having 5 or less carbon atoms include ethylene glycol, propylene glycol, trimethylene glycol, 1,4-butanediol, pentamethylene glycol, and neopentyl glycol, and 1,4-butanediol is preferable. The content of the aliphatic diol having 5 or less carbon atoms or 17 or more carbon atoms in the raw material may be 15 mol % or less, 1 to 12 mol %, or 3 to 10 mol % with respect to the total amount of the raw material.

Examples of the aliphatic diol having 17 or more carbon atoms include dotriacontanediol, tetratriacontanediol, and dimer diol (Pripol 2033 manufactured by Croda).

Examples of the alicyclic diol include isosorbide, tricyclodecanedimethanol, and cyclohexanedimethanol. Examples of the aromatic diol include an alkylene (2 or 3 carbon atoms) oxide adduct of bisphenol A.

### (Trihydric or Higher Polyhydric Alcohol)

The polyester resin of the present embodiment may include a trihydric or higher polyhydric alcohol from the viewpoints of washing durability and flexibility.

Examples of the trihydric or higher polyhydric alcohol include glycerin, trimethylolpropane, pentaerythritol, 1,2,4-butanetriol, 1,2,5-pentanetriol, 2-methyl-1,2,3-propanetriol, 2-methyl-1,2,4-butanetriol, 1,3,5-trihydroxymethylbenzene, 1,2,3,6-hexanetetraol, 1,4-sorbitan, dipentaerythritol, sorbitol, tripentaerythritol, and alkylene (2 or 3 carbon atoms) oxide adducts thereof. Among them, glycerin, trimethylolpropane, and pentaerythritol are preferable.

When the raw material includes a trihydric or higher polyhydric alcohol component, the content of the trihydric or higher polyhydric alcohol component may be 10 mol % or less, 0.1 to 10 mol %, or 0.3 to 6 mol % with respect to the total amount of the raw material.

The content of the polyhydric alcohol component other than the aliphatic diol having 6 to 16 carbon atoms in the raw material may be 30 mol % or less, 0.1 to 25 mol % or less, or 1 to 20 mol % or less with respect to the total amount of the raw material. As the polyhydric alcohol component other than the aliphatic diol having 6 to 16 carbon atoms, one kind or two or more kinds can be used.

### (Polycarboxylic Acid Component)

Examples of the polycarboxylic acid component include aliphatic polycarboxylic acids, alicyclic polycarboxylic acids, and aromatic polycarboxylic acids. In the present description, the term “component” used for a polycarboxylic acid means one or more of polycarboxylic acids, anhydrides thereof, or lower alkyl (for example, 1 to 3 carbon atoms) esters thereof. The polycarboxylic acid component may be either a dicarboxylic acid or a tricarboxylic or higher polycarboxylic acid. As the polycarboxylic acid component, one kind or two or more kinds can be used. The number of carbon atoms of the polycarboxylic acid is preferably 4 to 12, and more preferably 6 to 10. The content of the polycarboxylic acid component may be 40 mol % or less, 0.1 to 40 mol %, 0.3 to 38 mol %, or 0.5 to 35 mol % with respect to the total amount of the raw material. As the polycarboxylic acid component, one kind or two or more kinds can be used.

### (Dicarboxylic Acid)

Examples of the dicarboxylic acid include aliphatic dicarboxylic acids, alicyclic dicarboxylic acids, and aromatic dicarboxylic acids.

Examples of the aliphatic dicarboxylic acid include those having 2 to 16 carbon atoms such as succinic acid, glutaric acid, maleic acid, fumaric acid, adipic acid, pimelic acid, suberic acid, azelaic acid, sebacic acid, undecanedioic acid, dodecanedioic acid, hexadecanedioic acid, dodecenylsuccinic acid, and esters or anhydrides thereof. The number of carbon atoms of the aliphatic dicarboxylic acid may be 6 to 12 or 7 to 10. The aliphatic dicarboxylic acid may be a linear or branched dicarboxylic acid, and may be a linear dicarboxylic acid.

Examples of the alicyclic dicarboxylic acid include dimer diacids obtained by dimerizing a carboxylic acid having an unsaturated bond (Pripol 1009, Pripol 1006, and Pripol 1004 manufactured by Croda).

Examples of the aromatic dicarboxylic acid include terephthalic acid, isophthalic acid, phthalic acid, and naphthalenedicarboxylic acid. The raw material may include an isophthalic acid component for adjusting Tg. The content of the isophthalic acid component in the raw material may be less than 40 mol %, less than 35 mol %, or 10 mol % or more and less than 30 mol % with respect to the total amount of the raw material.

### (Tricarboxylic or Higher Polycarboxylic Acid)

From the viewpoints of washing durability and flexibility, the polyester resin of the present embodiment may include a tricarboxylic or higher polycarboxylic acid, and may be a tricarboxylic acid.

Examples of the tricarboxylic or higher polycarboxylic acid include trimellitic acid, naphthalenetricarboxylic acid, hexanetricarboxylic acid, esters or anhydrides thereof, pyromellitic acid, octanetetracarboxylic acid, and esters or anhydrides thereof. Trimellitic acid or an anhydride thereof is preferable from the viewpoint of industrial availability.

When the raw material includes a tricarboxylic or higher polycarboxylic acid component, the content of the tricarboxylic or higher polycarboxylic acid component may be 10 mol % or less, 0.1 to 10 mol %, 0.3 to 8 mol %, or 0.5 to 6 mol % with respect to the total amount of the raw material.

A tricarboxylic or higher polycarboxylic acid component may be subjected to an esterification reaction with the polycondensate of the raw material from the viewpoint of acid value adjustment. In this case, the polyester resin is a reaction product of a polycondensate obtained by a polycondensation reaction and a tricarboxylic or higher polycarboxylic acid component. Specific examples of the “tricarboxylic or higher polycarboxylic acid component” used here include those exemplified above as the component included in the raw material. The amount of the tricarboxylic or higher polycarboxylic acid component used in the esterification reaction can be adjusted according to the acid value of the polyester resin finally obtained, and the amount of the tricarboxylic or higher polycarboxylic acid component can be 5 parts by mole or less, 3 parts by mole or less, 0.01 to 2 parts by mole, or 0.1 to 1 part by mole based on 100 parts by mole of the total amount of the raw material used for polycondensation.

When the raw material further includes a trihydric or higher polyhydric alcohol component or a tricarboxylic or higher polycarboxylic acid component, the water dispersibility of the resulting polyester resin tends to be improved. From the viewpoint of molecular weight control, the total content of the trihydric or higher polyhydric alcohol and the tricarboxylic or higher polycarboxylic acid in the raw material is preferably 10 mol % or less, more preferably 8 mol % or less, and still more preferably 6 mol % or less. When the raw material includes only either the trihydric or higher polyhydric alcohol component or the tricarboxylic or higher polycarboxylic acid component, the preferable range of the content of the trihydric or higher polyhydric alcohol component or the tricarboxylic or higher polycarboxylic acid component in the raw material is the range of the content of the included component.

In the raw material composition, the range of the COOH/OH ratio of all components included in the raw material is preferably 0.55 to 1.10 from the viewpoint of smoother reaction progress. PET as a raw material is regarded as one mole of COOH and one mole of OH per mole of the structural unit (1).

When the polyester resin of the present embodiment is used as a binder for pigment printing, the polyester resin is desirably blended as an aqueous dispersion or emulsion. Accordingly, from the viewpoint of particle size control during dispersion or emulsification of the resin, the acid value of the polyester resin is preferably 5 to 20 mg KOH/g, more preferably 5.5 to 15 mg KOH/g, and still more preferably 6 to 13 mg KOH/g. When the acid value is 5 mg KOH/g or more, poor emulsification tends to be suppressed. When the acid value is 20 mg KOH/g or less, the hydrolyzability is suppressed, and the washing durability tends to be further improved. The acid value of the polycondensed polyester resin can also be adjusted to fall within the above range by appropriate reaction with a tricarboxylic or higher polycarboxylic acid component. Examples of the tricarboxylic or higher polycarboxylic acid component in this case include the tricarboxylic or higher polycarboxylic acid component described above. From the viewpoint of reactivity, the temperature at the time of the acid value adjustment can be adjusted to a reaction temperature of 180° C. to 230° C., and the acid value adjustment is preferably performed at a temperature condition of 190° C. to 220° C. under normal pressure or under increased pressure for 0.1 hours to 1 hour.

From the viewpoint of flexibility, the glass transition temperature of the polyester resin of the present embodiment is preferably 50° or lower, and more preferably 40° C. or lower.

From the viewpoint of washing durability or tack-free properties, the weight average molecular weight of the polyester resin of the present embodiment is preferably 10,000 or more, and more preferably 15,000 or more. From the viewpoint of printing ink fixation, the weight average molecular weight is preferably 200,000 or less, more preferably 150,000 or less, and particularly preferably 100,000 or less.

The polyester resin of the present embodiment may be any of a crystalline polyester resin, an amorphous polyester resin, or a mixture thereof, and may be an amorphous polyester resin. In the present description, the term “amorphous” polyester resin refers to a polyester resin that does not exhibit a clear crystal melting endothermic peak and has a melting enthalpy of 5 mJ/mg or less as determined from a melting endothermic peak area in a DSC (differential scanning calorimetry) curve. On the other hand, the “crystalline” polyester resin refers to a polyester resin that exhibits a clear crystal melting endothermic peak and has a melting enthalpy of more than 5 mJ/mg. The value of the melting enthalpy is a value determined using indium and tin as standard substances.

### <Production Method for Polyester Resin>

The production method for a polyester resin of the present embodiment includes the step of polycondensing a raw material to obtain a polycondensate, in which the raw material includes (a) polyethylene terephthalate and (b) an aliphatic diol having 6 to 16 carbon atoms, the content of the component (a) in the raw material may be 30 to 80 mol % with respect to the total amount of the raw material, and the content of the component (b) in the raw material may be 20 to 50 mol % with respect to the total amount of the raw material. The raw material may optionally include at least one of a polyhydric alcohol component or a polycarboxylic acid component other than the aliphatic diol having 6 to 16 carbon atoms described above. The production method for a polyester resin of the present embodiment may further include the step of reacting a tricarboxylic or higher polycarboxylic acid component with the obtained polycondensate.

In the present embodiment, from the viewpoints that the reaction time is shortened and decomposition of the resin is suppressed, the temperature at the time of performing the polycondensation reaction can be set to 200° C. to 300° C., preferably 210° C. to 270° C., and the polycondensation reaction is more preferably performed at a temperature condition of 220° C. to 250° C. under normal pressure, under reduced pressure, or tinder increased pressure, preferably under reduced pressure, for 3 to 20 hours.

In the polycondensation reaction, it is possible to use conventionally known catalysts, for example, antimony trioxide, organotin-based polymerization catalysts such as dibutyltin oxide, germanium-based catalysts, inorganic titanium-based catalysts, organotitanium-based catalysts such as n-tetrabutoxytitanium and tetraisopropoxytitanium, organoaluminum-based catalysts, organocobalt-based catalysts, organozirconium-based catalysts, and transesterification catalysts such as zine acetate and manganese acetate, as necessary. Among them, germanium-based catalysts, inorganic titanium-based catalysts, organotitanium-based catalysts, organozirconium-based catalysts, organoaluminum-based catalysts, and the like are preferred.

An antioxidant may be added to the polyester resin of the present embodiment at any stage in the production process thereof or after the production thereof for the purpose of preventing coloring and thermal decomposition. Such an antioxidant is not particularly limited, and examples thereof include hindered phenol antioxidants, phosphite antioxidants, and sulfur-including antioxidants.

### <Polyester Resin Aqueous Emulsion Dispersion>

The polyester resin of the present embodiment is desirably blended as an aqueous emulsion dispersion in the binder for pigment printing. The polyester resin of the present embodiment may be included in an aqueous dispersion that includes an aqueous medium and particles including the polyester resin dispersed in the aqueous medium. Examples of the aqueous medium include water, and a mixed solvent of a solvent miscible with water (for example, lower alcohols having 1 to 4 carbon atoms or glycols, ketones such as methyl ethyl ketone and acetone, and tetrahydrofuran) and water. Examples of the dispersion or emulsification method include a method using a media-type disperser (bead mill) or a high-pressure type disperser (homogenizer or Ultimizer), and a phase inversion emulsification method in which water is added to a solution obtained by dissolution into an organic solvent to invert the phase from an oil phase to an aqueous phase. If necessary, a nonionic surfactant or an anionic surfactant can be used as the emulsifier.

### <Binder for Pigment Printing>

The binder for pigment printing of the present embodiment can include components other than the polyester resin aqueous emulsion dispersion. The component is not particularly limited, and can be appropriately selected according to the purpose, and examples thereof include conventionally known components such as a colorant including a pigment, inorganic fine particles, organic fine particles, a charge control agent, a release agent, and a thickener.

### <Ink for Pigment Printing>

The ink for pigment printing includes a binder for pigment printing. The ink may include, as components other than the binder for pigment printing, additional components such as pigments, for example, a white pigment for base shielding, a coloring pigment, an extender pigment, and a glitter pigment, an ultraviolet absorber, an antioxidizing agent, an organic solvent, a film forming aid, and a rheology control agent. The additional component may be a combination of two or more kinds.

Examples of the white pigment for base shielding include white pigments having high shielding properties such as titanium dioxide and zinc oxide, and titanium dioxide is preferable from the viewpoint that high light shielding properties are obtained.

Examples of the coloring pigment include titanium oxide, zinc white, carbon black, molybdenum red, Prussian blue, cobalt blue, azo pigments, phthalocyanine pigments, quinacridone pigments, isoindoline pigments, threne pigments, and perylene pigments, and titanium oxide and/or carbon black are preferable. The coloring pigment may be a combination of two or more kinds.

Examples of the extender pigment include clay, kaolin, barium sulfate, barium carbonate, calcium carbonate, tale, silica, and alumina white, barium sulfate and/or talc are preferable, and barium sulfate is more preferable. The extender pigment may be a combination of two or more kinds.

Examples of the glitter pigment include metal pigments such as aluminum brass, bronze, nickel, stainless steel, and zinc; mica coated with titanium oxide, yellow iron oxide, or the like; flaky crystals or plate-like crystals such as aluminosilicates, basic carbonates, barium sulfate, titanium oxide, and bismuth oxychloride; flaky glass powder, and metal vapor-deposited flaky glass powder. Among them, a metal pigment is preferable from the viewpoint of specular reflection intensity, and a metal pigment having a flat shape is more preferable from the viewpoint of higher specular reflection intensity. Among the metal pigments, an aluminum pigment is desirable from the viewpoint that a flat powder is easily obtained. The surface of the metal pigment may be coated with silica, an acrylic resin, a polyester resin, or the like.

The content of the pigment in the pigment printing ink is preferably 1 part by mass to 70 parts by mass, and more preferably 5 parts by mass to 50 parts by mass with respect to 100 parts by mass of the polyester resin of the present embodiment.

### <Fiber Base Material>

The base material to which the ink for pigment printing is applied is not particularly limited. For example, when the base material is a fiber base material, the base material may be in the form of a nonwoven fabric, a woven fabric, a knitted fabric, or the like. Examples of the material of the fiber base material include natural fibers such as cotton (cellulose fibers), hemp, wool, and silk, synthetic fibers such as acrylic, nylon, polyurethane, and vinylon, semi-synthetic fibers such as acetate and triacetate, regenerated fibers such as cupra, lyocell, and rayon, and composite fibers obtained by blending, cross weaving, and co-knitting these fibers. In the case of the resin base material, the resin base material may be in the form of a film or a molded product, and examples of the material thereof include polyethylene, polypropylene, polyethylene terephthalate, polyethylene naphthalate, a vinyl chloride resin, polystyrene, acrylic, polycarbonate, polyurethane, nylon, polyimide, and PTFE (fluorine).

### <Printing Method>

The method for applying the ink for pigment printing of the present embodiment to a fiber base material is not particularly limited, but examples thereof include silk screen, roller, inkjet, and bar coater, and a part or the entire surface of the fiber base material, a transfer paper, a transfer sheet, or the like can be coated with the ink. After coating, drying is performed at a temperature of 50° C. to 180° C. for 5 minutes to 1 hour. When a transfer paper or a transfer sheet is coated, the fiber base material and the transfer paper or the transfer sheet are overlaid such that the ink-coated surface of the transfer paper or the transfer sheet faces to the fiber base material, hot pressed at 100° C. to 200° C., and then the transfer paper or the transfer sheet is peeled off from the fiber base material, whereby a printed article in which the fiber base material and the ink are integrated can be obtained.

### EXAMPLES

### <Production of Polyester Resin>

### Synthesis Examples 1 and 2

A raw material having a composition shown in Table 3 was charged into a reaction vessel sufficiently dried in advance, and heated to 180° C. while being stirred under nitrogen flow. Here, n-tetrabutoxytitanium was charged as a catalyst, the temperature was increased to 230° C., and a polycondensation reaction was carried out under reduced pressure until the pressure in the reaction vessel finally reached 3 kPa, obtaining a polyester resin (A-1 and A-2).

The amount of the catalyst charged was 0.1 nmol when the total number of moles of the alcohol component, the carboxylic acid component, and other components was 100.

### Synthesis Examples 3 to 20

A raw material having each composition shown in Table 3 or 4 was charged into a reaction vessel sufficiently dried in advance, and heated to 180° C. while being stirred under nitrogen flow. Here, n-tetrabutoxytitanium (TBT) was charged as a catalyst, the temperature was increased to 230° C., and a polycondensation reaction was carried out tinder reduced pressure until the pressure in the reaction vessel finally reached 3 kPa. Thereafter, the pressure was returned to normal pressure, and the mixture was cooled to 200° C. while being stirred under nitrogen flow. Then, trimellitic anhydride was added to the polyester resin obtained by polycondensation, and polycondensation reaction further proceeded, obtaining each of the polyester resins A-3 to A-17 and B-1 to B-2. In Synthesis Example 19, the reaction mixture was solidified in the middle of the polycondensation reaction, and a polyester resin could not be synthesized (in Tables 3 to 8, the synthesis example is described as B-3). In Tables 3 and 4, trimellitic anhydride (1) refers to trimellitic anhydride included in the raw material at the time of polycondensation with PET, and trimellitic anhydride (2) refers to trimellitic anhydride added after the polycondensation. In Tables 3 and 4, the total raw material is the total amount of the monomer components (PET, polyhydric alcohol component, and polycarboxylic acid component (excluding trimellitic anhydride for acid value adjustment)) used in the polycondensation reaction, and the amount of the catalyst and the trimellitic anhydride (2) is the amount (parts by mole) added when the total number of moles of the raw material is 100 parts by mole.

In Tables 5 and 6, the amounts of the raw materials used in Synthesis Examples 1 to 20 are represented by mass.

### <Weight Average Molecular Weight (Mw)>

The polyester resin, 2 mg, was added to and dissolved in 5 mL of tetrahydrofuran, and the weight average molecular weight was determined in terms of polystyrene by gel permeation chromatography (GPC)-ILC-8220GPC (manufactured by Tosoh Corporation). The measurement conditions of GPC were as follows. The results are shown in Tables 7 and 8.

### <Measurement Conditions>

Detection device: RI detector
Mobile phase: tetrahydrofuran
Column: two Tsk-gel Super HZ 2000 columns and one Tsk-gel Super HZ 4000 column were connected in series.
Temperature of sample injector and column: 40° C.
RI detector temperature: 40° C.
Sample injection amount: 5 μL
Flow rate: 0.35 mL/min
Measurement time: 20 minutes

### <Glass Transition Temperature (Tg)>

The glass transition temperature of the polyester resin was measured by DSC. As a measuring apparatus, a differential scanning calorimeter DSC-7020 (manufactured by Hitachi High-Tech Science Corporation) was used. The measurement conditions of Tg were as follows. The results are shown in Tables 7 and 8.

### <Measurement Conditions>

Rates of temperature increase and temperature decrease: 10° C./min

Temperature increasing program: The temperature of the aluminum pan was increased from −50° C. to 100° C., and then decreased to −50° C. Next, the temperature at the intersection between the baseline of the chart and the tangent to the endothermic curve located around the glass transition temperature when the temperature was increased to 100° C. was defined as the glass transition temperature (Tg).
Atmosphere: in a nitrogen stream (30 mL/min)
Cell: sealed aluminum
Sample amount: 5.0 mg±1.0 mg
Standard substance: indium, tin

### <Acid Value (AV)>

The acid value of the polyester resin was measured by JIS K 0070 (1992) 3.2 potentiometric titration method in which only the following conditions were changed. The results are shown in Tables 7 and 8.
Titration solvent: 0.1 mol/L aqueous sodium hydroxide solution
Measurement solvent: mixed solvent of tetrahydrofuran: water=10:1 (volume ratio)
Solvent amount: 100 mL
Sample amount: 5.0 g±0.5 g

### <Preparation of Polyester Resin Aqueous Emulsion Dispersion>

### Preparation Example LA-1

The polyester resin (A-1), 100 parts by mass, and 150 parts by mass of tetrahydrofuran were placed in a container to dissolve the resin. While the temperature is maintained at 40° C. to 50° C., 5 parts by mass of a 5 mass % aqueous ammonia solution was added, and in addition, 400 parts by mass of ion-exchanged water was gradually added to perform phase inversion emulsification, and then tetrahydrofuran was distilled off under reduced pressure conditions. Thereafter, ion-exchanged water was added to adjust the solid content concentration to 20 mass %, thereby obtaining a polyester resin emulsion (LA-1).

As shown in Tables 7 and 8, polyester resin aqueous emulsion dispersions (LA-2 to LA-17, LB-1 and LB-2) were similarly obtained.

### <Preparation of Ink for Printing>

Each polyester resin aqueous emulsion dispersion, 100 parts by mass, and 20 parts by mass of titanium oxide as a white pigment were placed in a stirring container, and stirred with a homogenizer. After it was confirmed that the mixture was sufficiently and uniformly mixed, 4 parts by mass of NEOSTECKER V (manufactured by NIKKA CHEMICAL CO., LTD.) as a thickener was added to prepare an ink for printing.

### <Preparation of Printed Article>

A PET transfer sheet was subjected to printing using a coating machine, and the sheet was dried with a dryer at 100° C. After the taken out transfer sheet was cooled to room temperature, the transfer sheet was overlaid on a polyester base material (black) such that the printed surface was in contact with the polyester base material, and thermocompressioni bonded at 130° C. for 30 seconds with a press machine. After the base material and the transfer sheet were cooled to room temperature, the transfer sheet was peeled off from the base material.

The polyester base material used for evaluation was prepared by the following method and used for preparation of a printed article.

A polyester 100% knit (basis weight: 120 g/m²) was put into a dyeing bath having a composition shown in the following Table 1 prepared so as to have a bath ratio of 1:12, the temperature of the dyeing bath was increased from 60° C. to 130° C. at a rate of temperature increase of 2° C./min (temperature increasing time: 35 minutes), and held at 130° C. for 30 minutes. Thereafter, the temperature was decreased to 70° C., and the knit was taken out of the dyeing bath. Then, the taken-out knit was subjected to reduction cleaning (80° C., 15 min, bath ratio 1:12) using a reduction cleaning bath having a composition shown in the following Table 2, then washed with water, dehydrated, and dried to prepare a polyester dyed product, and the polyester dyed product was used as a polyester base material.

TABLE 1

| | | | |
|---|---|---|---|
| Dispersing and Leveling agent | NICCASUNSOLT RM-3406 | 0.5 | g/l |
| pH control agent | 80 mass % Acetic acid | 0.4 | g/l |
| Disperse dye | Disperseblack PB-SF300% | 3% | o.w.f |

TABLE 2

| | | |
|---|---|---|
| Soaping agent | SUNMORL RC-700E conc. | 0.5 g/l |
| Alkaline agent | Soda ash | 1.0 g/l |
| Reducing agent | Sodium hydrosulfite | 1.0 g/l |

### <Washing Durability>

The washing durability (washing fastness) of the image-formed article was evaluated in accordance with JIS L1930:2014 C4M method. That is, the change in the printed portion was evaluated by comparing the image-formed article after washing using Attack Highly-Active Bio-EX (manufactured by Kao Corporation) as a detergent with the inage-formed article that was not washed. Then, evaluation was performed based on the following evaluation criteria.
A: No change in the printed portion
B: The printed portion becomes thinner
C: The printed portion is cracked
D: The printed portion is completely peeled off

### <Flexibility>

Using the fabric subjected to printing, a 2 cm printed surface portion was pulled over 3 seconds to 3 cm, and how much the printed portion stretched due to deformation of the fabric was evaluated. The results were visually evaluated according to the following grades.
A: The printed portion stretched with the fabric
B: The printed portion stretched with the fabric, but was slightly cracked
C: The printed portion stretched with the fabric but had a large crack
D: The printed portion did not stretch with the fabric, had a large crack, and was partially peeled off

### <Tack-Free Properties>

After printing with the printing transfer sheet, the presence or absence of tackiness was evaluated when the sheet was peeled off. The results were evaluated according to the following grades by a sensory test. The sensory test was performed by pressing an index finger to the printed portion for 3 seconds, and then releasing the index finger directly above the printed portion to evaluate the degree of sticking of the printed portion to the finger.
A: When the transfer sheet is peeled off, the printed portion does not stick to the finger
B: When the transfer sheet is peeled off, the printed portion sticks to the finger but immediately separates
C: When the transfer sheet is peeled off, the printed portion is slightly lifted and then separates
D: When the transfer sheet is peeled off, the printed portion is lifted up and does not separate

TABLE 3

| | | Synthesis example number | | | | | | | | | |
|---|---|---|---|---|---|---|---|---|---|---|---|
| | | Syn- | Syn- | Syn- | Syn- | Syn- | Syn- | Syn- | Syn- | Syn- | Syn- |
| | | thesis | thesis | thesis | thesis | thesis | thesis | thesis | thesis | thesis | thesis |
| | | exam- | exam- | exam- | exam- | exam- | exam- | exam- | exam- | exam- | exam- |
| | | ple 1 | ple 2 | ple 3 | ple 4 | ple 5 | ple 6 | ple 7 | ple 8 | ple 9 | ple 10 |
| Polyester resin | | A-1 | A-2 | A-3 | A-4 | A-5 | A-6 | A-7 | A-8 | A-9 | A-10 |
| Raw material | PET | 35.7 | 34.8 | 30.9 | 37.0 | 49.4 | 61.7 | 70.4 | 54.9 | 52.1 | 62.5 |
| (mol %) | 1,4- | — | — | — | — | — | — | — | — | — | — |
| | Butanediol | | | | | | | | | | |
| | 1,6- | — | — | — | — | — | — | 28.2 | 44.0 | 46.9 | 37.5 |
| | Hexanediol | | | | | | | | | | |
| | 1,9- | 32.1 | 31.6 | 37.0 | 37.0 | 37.0 | 37.0 | — | — | — | — |
| | Nonanediol | | | | | | | | | | |
| | Azelaic acid | — | — | — | — | — | — | — | — | — | — |
| | Isophthalic | 32.1 | 30.4 | 30.9 | 24.7 | 12.3 | — | — | — | — | — |
| | acid | | | | | | | | | | |
| | Trimellitic | — | 3.2 | 1.2 | 1.2 | 1.2 | 1.2 | 1.4 | 1.1 | 1.0 | — |
| | anhydride (1) | | | | | | | | | | |
| | Total raw | 100.0 | 100.0 | 100.0 | 100.0 | 100.0 | 100.0 | 100.0 | 100.0 | 100.0 | 100.0 |
| | material | | | | | | | | | | |
| Acid value | Trimellitic | — | — | 0.9 | 0.9 | 0.9 | 0.9 | 0.9 | 0.9 | 0.9 | 0.9 |
| adjustment | anhydride (2) | | | | | | | | | | |
| (parts by | Total | 100.0 | 100.0 | 100.9 | 100.9 | 100.9 | 100.9 | 100.9 | 100.9 | 100.9 | 100.9 |
| mole) | | | | | | | | | | | |
| Catalyst (parts | TBT | 0.1 | 0.1 | 0.1 | 0.1 | 0.1 | 0.1 | 0.1 | 0.1 | 0.1 | 0.1 |
| by mole) | | | | | | | | | | | |

| | | | | | | | | | | |
|---|---|---|---|---|---|---|---|---|---|---|
| COOH/OH mole ratio of all | 1.000 | 1.052 | 0.956 | 0.877 | 0.751 | 0.657 | 0.749 | 0.586 | 0.556 | 0.639 |
| charged components | | | | | | | | | | |

TABLE 4

| | | Synthesis example number | | | | | | | | | |
|---|---|---|---|---|---|---|---|---|---|---|---|
| | | Syn- | Syn- | Syn- | Syn- | Syn- | Syn- | Syn- | Syn- | Syn- | Syn- |
| | | thesis | thesis | thesis | thesis | thesis | thesis | thesis | thesis | thesis | thesis |
| | | exam- | exam- | exam- | exam- | exam- | exam- | exam- | exam- | exam- | exam- |
| | | ple 11 | ple 12 | ple 13 | ple 14 | ple 15 | ple 16 | ple 17 | ple 18 | ple 19 | ple 20 |
| Polyester resin | | A-11 | A-12 | A-13 | A-14 | A-15 | A-16 | B-1 | B-2 | B-3 | A-17 |
| Raw material | PET | 62.1 | 61.7 | 60.6 | 58.8 | 46.5 | 49.5 | — | 82.0 | 61.7 | 46.9 |
| (mol %) | 1,4- | — | — | — | — | 5.8 | — | — | — | 37.0 | 5.9 |
| | Butanediol | | | | | | | | | | |
| | 1,6- | 37.3 | 37.0 | 36.4 | 35.3 | — | 44.6 | — | 16.4 | — | — |
| | Hexanediol | | | | | | | | | | |
| | 1,9- | — | — | — | — | 34.9 | — | 49.5 | — | — | 35.2 |
| | Nonanediol | | | | | | | | | | |
| | Azelaic acid | — | — | — | — | — | 5.0 | — | — | — | — |
| | Isophthalic | — | — | — | — | 11.6 | — | 49.5 | — | — | 9.1 |
| | acid | | | | | | | | | | |
| | Trimellitic | 0.6 | 1.2 | 3.0 | 5.9 | 1.2 | 1.0 | 1.0 | 1.6 | 1.2 | 2.9 |
| | anhydride (1) | | | | | | | | | | |
| | Total raw | 100.0 | 100.0 | 100.0 | 100.0 | 100.0 | 100.0 | 100.0 | 100.0 | 100.0 | 100.0 |
| | material | | | | | | | | | | |
| Acid value | Trimellitic | 0.9 | 0.9 | 0.9 | 0.9 | 0.9 | 0.9 | 0.9 | 0.9 | 0.9 | 0.9 |
| adjustment | anhydride (2) | | | | | | | | | | |
| (parts by | Total | 100.9 | 100.9 | 100.9 | 100.9 | 100.9 | 100.9 | 100.9 | 100.9 | 100.9 | 100.9 |
| mole) | | | | | | | | | | | |
| Catalyst (parts | TBT | 0.1 | 0.1 | 0.1 | 0.1 | 0.1 | 0.1 | 0.1 | 0.1 | 0.1 | 0.1 |
| by mole) | | | | | | | | | | | |

| | | | | | | | | | | |
|---|---|---|---|---|---|---|---|---|---|---|
| COOH/OH mole ratio of all | 0.648 | 0.657 | 0.686 | 0.733 | 0.702 | 0.609 | 1.057 | 0.872 | 0.657 | 0.702 |
| charged components | | | | | | | | | | |

TABLE 5

| | | Synthesis example number | | | | | | | | | |
|---|---|---|---|---|---|---|---|---|---|---|---|
| | | Syn- | Syn- | Syn- | Syn- | Syn- | Syn- | Syn- | Syn- | Syn- | Syn- |
| | | thesis | thesis | thesis | thesis | thesis | thesis | thesis | thesis | thesis | thesis |
| | | exam- | exam- | exam- | exam- | exam- | exam- | exam- | exam- | exam- | exam- |
| | | ple 1 | ple 2 | ple 3 | ple 4 | ple 5 | ple 6 | ple 7 | ple 8 | ple 9 | ple 10 |
| Polyester resin | | A-1 | A-2 | A-3 | A-4 | A-5 | A-6 | A-7 | A-8 | A-9 | A-10 |
| Raw material | PET | 396 | 384 | 341 | 405 | 531 | 652 | 782 | 654 | 629 | 723 |
| (g) | 1,4- | — | — | — | — | — | — | — | — | — | — |
| | Butanediol | | | | | | | | | | |
| | 1,6- | — | — | — | — | — | — | 192 | 322 | 348 | 267 |
| | Hexanediol | | | | | | | | | | |
| | 1,9- | 297 | 291 | 341 | 338 | 332 | 326 | — | — | — | — |
| | Nonanediol | | | | | | | | | | |
| | Azelaic acid | — | — | — | — | — | — | — | — | — | — |
| | Isophthalic | 308 | 290 | 295 | 234 | 115 | — | — | — | — | — |
| | acid | | | | | | | | | | |
| | Trimellitic | — | 35 | 14 | 14 | 13 | 13 | 16 | 13 | 13 | — |
| | anhydride (1) | | | | | | | | | | |
| Acid value | Trimellitic | — | — | 10 | 10 | 10 | 9 | 10 | 11 | 11 | 10 |
| adjustment (g) | anhydride (2) | | | | | | | | | | |
| | Total | 1000 | 1000 | 1000 | 1000 | 1000 | 1000 | 1000 | 1000 | 1000 | 1000 |
| Catalyst (g) | TBT | 2 | 2 | 2 | 2 | 2 | 2 | 2 | 2 | 2 | 2 |

TABLE 6

| | | Synthesis example number | | | | | | | | | |
|---|---|---|---|---|---|---|---|---|---|---|---|
| | | Syn- | Syn- | Syn- | Syn- | Syn- | Syn- | Syn- | Syn- | Syn- | Syn- |
| | | thesis | thesis | thesis | thesis | thesis | thesis | thesis | thesis | thesis | thesis |
| | | exam- | exam- | exam- | exam- | exam- | exam- | exam- | exam- | exam- | exam- |
| | | ple 11 | ple 12 | ple 13 | ple 14 | ple 15 | ple 16 | ple 17 | ple 18 | ple 19 | ple20 |
| Polyester resin | | A-11 | A-12 | A-13 | A-14 | A-15 | A-16 | B-1 | B-2 | B-3 | A-17 |
| Raw material | PET | 718 | 712 | 697 | 674 | 514 | 592 | — | 867 | 760 | 517 |
| (g) | 1,4- | — | — | — | — | 30 | — | — | — | 214 | 30 |
| | Butanediol | | | | | | | | | | |
| | 1,6- | 265 | 263 | 257 | 249 | — | 328 | — | 107 | — | — |
| | Hexanediol | | | | | | | | | | |
| | 1,9- | — | — | — | — | 322 | — | 480 | — | — | 323 |
| | Nonanediol | | | | | | | | | | |
| | Azelaic acid | — | — | — | — | — | 58 | — | — | — | — |
| | Isophthalic | — | — | — | — | 111 | — | 498 | — | — | 87 |
| | acid | | | | | | | | | | |
| | Trimellitic | 7 | 14 | 35 | 67 | 13 | 12 | 12 | 17 | 15 | 32 |
| | anhydride (1) | | | | | | | | | | |
| Acid value | Trimellitic | 10 | 10 | 10 | 10 | 10 | 11 | 10 | 10 | 11 | 10 |
| adjustment | anhydride (2) | | | | | | | | | | |
| (g) | Total | 1000 | 1000 | 1000 | 1000 | 1000 | 1000 | 1000 | 1000 | 1000 | 1000 |
| Catalyst (g) | TBT | 2 | 2 | 2 | 2 | 2 | 2 | 2 | 2 | 2 | 2 |

TABLE 7

| | | Example number | | | | | | | | | |
|---|---|---|---|---|---|---|---|---|---|---|---|
| | | Exam- | Exam- | Exam- | Exam- | Exam- | Exam- | Exam- | Exam- | Exam- | Exam- |
| | | ple 1 | ple 2 | ple 3 | ple 4 | ple 5 | ple 6 | ple 7 | ple 8 | ple 9 | ple 10 |
| Polyester resin | | A-1 | A-2 | A-3 | A-4 | A-5 | A-6 | A-7 | A-8 | A-9 | A-10 |
| Polyester resin aqueous | | LA-1 | LA-2 | LA-3 | LA-4 | LA-5 | LA-6 | LA-7 | LA-8 | LA-9 | LA-10 |
| emulsion dispersion | | | | | | | | | | | |
| Physical | Mw | 17100 | 19400 | 41000 | 38800 | 32700 | 22700 | 16900 | 22500 | 26900 | 16300 |
| properties | Tg(° C.) | −1.5 | −4.1 | −2.2 | 0.9 | 6.7 | 8.2 | 23.8 | 15.7 | 11.7 | 19.9 |
| | AV (mg KOH/g) | 6.1 | 10.9 | 8.6 | 8 | 9.2 | 7.9 | 8.1 | 10.3 | 9.4 | 7.9 |
| Evaluation | Washing | B | A | B | B | A | A | A | A | B | B |
| | durability | | | | | | | | | | |
| | Flexibility | B | A | A | B | A | A | B | A | A | B |
| | Tack-free | A | A | B | A | A | A | A | A | A | A |
| | properties | | | | | | | | | | |

TABLE 8

| | | Example number | | | | | | | | | |
|---|---|---|---|---|---|---|---|---|---|---|---|
| | | Exam- | Exam- | Exam- | Exam- | Exam- | Exam- | Comparative | Comparative | Comparative | Exam- |
| | | ple 11 | ple 12 | ple 13 | ple 14 | ple 15 | ple 16 | example 1 | example 2 | example 3 | ple 17 |
| Polyester resin | | A-11 | A-12 | A-13 | A-14 | A-15 | A-16 | B-1 | B-2 | B-3 | A-17 |
| Polyester resin aqueous emulsion | | LA-11 | LA-12 | LA-13 | LA-14 | LA-15 | LA-16 | LB-1 | LB-2 | Not | LA-17 |
| dispersion | | | | | | | | | | synthesizable | |
| Physical | Mw | 20500 | 18200 | 31600 | 40500 | 31800 | 30300 | 65300 | 11900 | Not | 80000 |
| properties | | | | | | | | | | measurable | |
| | Tg(° C.) | 25.3 | 20.7 | 19 | 17.5 | 4.2 | 7.7 | −17.7 | 68 | — | 4.5 |
| | AV (mg KOH/g) | 9.4 | 8.2 | 8.7 | 10.3 | 10.2 | 9.3 | 7.6 | 7 | Not | 9.5 |
| | | | | | | | | | | measurable | |
| Evaluation | Washing durability | A | A | A | A | A | B | C | A | — | A |
| | Flexibility | A | A | A | A | A | A | A | C | — | A |
| | Tack-free properties | A | A | A | A | A | A | D | A | — | A |

1. A polyester resin that is a poly condensate of a raw material including (a) polyethylene terephthalate and (b) an aliphatic diol having 6 to 16 carbon atoms, wherein
a content of the component (a) in the raw material is 30 to 80 mol % with respect to a total amount of the raw material, and
a content of the component (b) in the raw material is 20 to 50 mol % with respect to the total amount of the raw material.

2. The polyester resin according to claim 1, wherein the aliphatic diol is a linear aliphatic diol.

3. The polyester resin according to claim 1, wherein the raw material further includes at least one selected from the group consisting of a trihydric or higher polyhydric alcohol component and a tricarboxylic or higher polycarboxylic acid component.

4. The polyester resin according to claim 3, wherein the polycarboxylic acid includes 4 to 12 carbon atoms.

5. The polyester resin according to claim 1, wherein the polyester resin is a reaction product obtained by reacting the polycondensate with a tricarboxylic or higher polycarboxylic acid component.

6. The polyester resin according to claim 1, having an acid value of 5 to 20 mg KOH/g.

7. A binder for pigment printing, including an aqueous emulsion dispersion of the polyester resin according to claim 1.

8. An ink for pigment printing, including the binder for pigment printing according to claim 7.

9. A production method for a polyester resin,
the method comprising the step of polycondensing a raw material to obtain a polycondensate, wherein
the raw material includes (a) polyethylene terephthalate and (b) an aliphatic diol having 6 to 16 carbon atoms,
a content of the component (a) in the raw material is 30 to 80 mol % with respect to a total amount of the raw material, and
a content of the component (b) in the raw material is 20 to 50 mol % with respect to the total amount of the raw material.

10. The production method for a polyester resin according to claim 9, further comprising the step of reacting a tricarboxylic or higher polycarboxylic acid component with the polycondensate obtained.
